(19) United States
(12) Patent Application Publication
(10) Pub. No.: US 2010/0293498 A1
(43) Pub. Date: Nov. 18, 2010

(54) Bible Interface for Computer

(76) Inventor: Larenzo Maxfield, Garland, TX (US)

Correspondence Address: RUDOLPH J. BUCHEL JR., LAW OFFICE OF, P. O. BOX 702526, DALLAS, TX, 75370-2526, US

(21) Appl. No.: 12/454,228

(22) Filed: May 14, 2009

(51) Int. Cl. G06F 3/048

(52) U.S. Cl. 715/776; 715/856

(57) ABSTRACT

A special purpose interface is disclosed for accessing computerized sacred text residing is an electronic memory using the same syntax and citation format as the comparable printed text. By articulating an object on the special purpose interface, different Books, chapters and verses of the sacred text may be accessed and displayed on a screen, as well as a separate version of the sacred text, separate translations of the various versions, separately or as in an adjacent column form for comparisons. The present special purpose interface may be implemented as a graphical user interface, a touch screen user interface or a manually actuation user interface. The present special purpose interface includes a plurality of graphical interactive objects that correspond with the traditional syntactic elements of citation to a sacred text.

### BACKGROUND OF THE INVENTION

The present invention relates generally to computerized sacred text. More particularly, the present invention relates to a system, method and software program product for implementing an interface for efficiently accessing sacred text.

Since before the time of the Pharos, humans have attempted to codify religious doctrines as sacred text that might be understood by the masses, or at least privileged members of the society. Often, the teachings of the various religions may be quite voluminous requiring one or many books of sacred text to set out doctrine. Individual books are usually organized by idea, chronology, author, lesson, event, story or combinations of the aforementioned. In some religions, such as Christianity, Judaism and Islam, these divisions are sometimes referred to as chapters. Chapters may have unique names, abbreviations of chapter names or numbered. The Christian Bible and Hebrew Tanakh divide each book into numbered chapters, while other religions refer to chapters by name. Within each chapter may be tens of pages of text that may convey differing thoughts, ideas and doctrine, so are often further delineated as sub-chapter divisions, such as verses in the Christian and Hebrew Bibles. Frequently, religious scholars will combine many books into a single integrated volume that contains an entire sacred text for the religion. The individual Books are given unique names, often relating to their subject matter, author or general theme, again such as the Christian and Hebrew Bibles. In so doing, every passage can be identified as coming from a chapter and verse of a particular book; the accepted Christian citation is “Book chapter: verse”, e.g., John 3:16. These consolidated Holy Books have been wildly successful through the ages, enabling even those of modest means and education to look up and read important scripture.

The written sacred text often contain Table of Contents, Index and Concordance sections for looking up particular passages or just for finding the location of a particular Book, however, many books are marked by labeled tabs or thumb indices that identify the various Books by location. Readers of the sacred text can then turn immediately to a Book, and thumb through its chapters for a particular verse.

The evolution of many sacred texts is not a straight forward dissertation from a single author or authors over a relatively short time period. Instead, many sacred scriptures were written at different times, in different geographic locations and in different languages. For example, it is widely accepted that much of the Old Testament of the Holy Bible was primarily written in Hebrew with some small portions in an ancient dialect of Aramaican, while the New Testament was written in Greek. Through the centuries, the Holy Bible has been retranslated from its original language into the colloquial languages of that time period. For example, at the Council of Rome in AD 382, Pope Damasus I assembled the first list of books of the Bible which was translated from Greek and Hebrew texts into Latin and then in 1611 the Church of England, authorized by King James, translated the Latin text into old English, which was published as the King James Version. In 1971, a literal translation of the Hebrew, Aramaic, and Greek Holy scriptures into modern “Americanized” English was compiled in the New American Standard Bible. The New International Version of the Bible, fully released in 1984, and the Today's New International Version of the Bible, released in 2002, are attempts by Biblical scholars to produce an accurate and readable translation in contemporary language that is supplemented with relevant parallel idioms. Additionally, the Amplified Bible attempts to provide further clarity of the Holy Scriptures from both word meaning and context in order to more accurately translate the text from its original language. Some passages include multiple English word equivalents for key Hebrew and Greek text to clarify and amplify meanings that may have been overlooked by earlier translation methods.

Clearly, a serious understudy of a sacred text may be faced with a relatively large number of versions and transitions of the scripture for consumption. In researching a specific topic, the user may search for relevant passages, and then interpret them from multiple sources or translations of the sacred text. Obviously, such research may result in contribution from multiple scripture sources of the written sacred text.

More recently, the sacred text of the major religions has been digitally converted for use with a computer or other digital reading device. Often, the Books and chapters are converted to a hypertext document that is hyperlinked (or linked) directly to a followable reference on an index page for user interaction. The user merely points a screen pointer to a particular link and clicks. The linked passage is then displayed for the user. A typical linked index is organized by Book with links to the Book and its chapters, but other types of indexes and interfaces may be used. Each computerized sacred text will usually have a unique interface or browser for the user to access its passages, so if information from several versions or translations are desired, the user will normally invoke the reading application for each version. The relevant passages are looked up in accordance with the application's interface and passages displayed in the separate reader's browser.

Although the computerized text has been heralded as a great improvement over the printed text, many users have limited or no computer skills. Furthermore, a significant percentage of users are older and less able to copy with newer user interfaces. Therefore, it would be advantageous to implement a user interface that is similar to using a printed text.

### BRIEF SUMMARY OF THE INVENTION

The present invention is directed to a system, method and software product for accessing sacred text in computers using the same syntax and citation format as the comparable printed text. By articulating an object on the special purpose interface, different Books, chapters and verses of the sacred text may be accessed and displayed on a screen, as well as a separate version of the sacred text, separate translations of the various versions, separately or as in an adjacent column form for comparisons. The present special purpose interface may be implemented as a graphical user interface, a touch screen user interface or a manually actuation user interface. The present special purpose interface includes a plurality of graphical interactive objects displayed on a computer screen for interaction with a screen pointer gesture, and/or graphical interactive objects displayed touch screen for interaction with a touch gesture (stylus or human touch) and/or a tactile interactive objects on a keyboard for manual interaction with human touch. These objects correspond with the traditional syntactic elements of citation to a sacred text such as the Holy Bible.

Included in the graphical objects are separate objects that identify every Book of the sacred text. In addition, the present special purpose interface includes a “chapter” and a “verse” objects and numerical objects for accessing specific chapters within a Book by their chapter numbers and specific verse within a specific chapter by their verse numbers. The present special purpose interface enables the user to index a specific verse in exactly the same manner as she would the printed version of the sacred text, by using the accepted standardized citation. In accordance with other exemplary embodiments of the present invention, an optional display window is provided for visually acknowledging the user's input gestures using the accepted standardized citation for the inputs. Also optionally presented on the present special purpose interface are separate scrolling objects for separately scrolling through at least the chapters and verses of the sacred text. These objects include “Chapter Up” and “Chapter Down” objects as well as “Verse Up” and “Verse Down” objects. Optionally, the scrolling objects may be dual purpose, and activated for differing functions based on the type of media being accessed.

In accordance with other exemplary embodiments of the present invention, also included in the graphical objects are separate “text” objects that identify variants and versions of the sacred text. As many sacred text are translated at different times from a single original document, and because the phonetic, morphological, semantic, syntactic, and other features of a language change over time, and further because a translation of a sacred text may be supplemented with parallel idioms and the like, unique versions of the sacred text may simultaneously exist. These are separately accessible for display using separate objects that identify specific variants of the sacred text. An optional display window is provided for visually acknowledging the user's input gestures for the variant or version of the sacred text. In accordance with a similar exemplary embodiment of the present invention, also included in the graphical objects are separate objects that identify separate display languages for displaying the separate versions of the sacred text, along with an optional display window visually acknowledging the user's input gestures to the display language.

In accordance with still another exemplary embodiment of the present invention, a plurality of document display and management objects may be presented. These objects comprise a “Screen” object for toggling the current selection between the left hand portion of the display screen and the right hand portions for side-by-side comparisons of versions of a verse or chapter. Additionally, screens or elements of screen can be saved to a memory, deleted or retrieved from memory using an appropriate document management object.

In accordance with other exemplary embodiments of the present invention, the present special purpose interface may further comprise graphical objects for multimedia functionality, for instance, “audio” for accessing audio media for the version and language of the text. Other objects include “Rewind”, “Play”, “Fast Forward” and “Pause” that operate and control an optical disk or other electronic file of the sacred text. Optionally, articulating the “Audio” object will activate the dual-purpose functionality of the “Chapter Up”, “Chapter Down”, “Verse Up” and “Verse Down” objects for the audio media.

In accordance with a final exemplary embodiment of the present invention, the present special purpose interface may be implemented as a keyboard device for simultaneous use with the standard QWERT keyboard coupled to a PC, in the same desk space footprint as the QWERT keyboard without uncoupling the standard QWERT keyboard. The present special purpose keyboard is seen as auxiliary to the primary QWERT keyboard and will typically be connected and disconnected between usages of the QWERT keyboard. This is accomplished by using a serial bus for connecting the special purpose interface keyboard to the PC in combination with the standard QWERT keyboard, such as the Universal Serial Bus (USB), or wireless technology such as a proprietary wireless scheme, Bluetooth or even WiFi wireless networking technology. In addition, the present special purpose interface keyboard comprises legs or other means for elevating the special purpose keyboard, in place and above the QWERT keyboard connected to the PC. This enables both keyboards to operate in the same physical footprint at a computer station.

### BRIEF DESCRIPTION OF THE SEVERAL VIEWS OF THE DRAWINGS

The novel features believed characteristic of the present invention are set forth in the appended claims. The invention itself, however, as well as a preferred mode of use, further objectives and advantages thereof, will be best understood by reference to the following detailed description of an illustrative embodiment when read in conjunction with the accompanying drawings wherein:

FIG. 1 is a diagram of a special purpose interface for efficiently accessing Biblical sacred text in accordance with an exemplary embodiment of the present invention;

FIGS. 2A and 2B are diagrams of various exemplary displays of sacred text using the presently described special purpose interface in accordance with an exemplary embodiment of the present invention;

FIGS. 3A and 3B are diagrams of various exemplary side-by-side displays of different versions, language or passages of sacred text using the presently described special purpose interface in accordance with an exemplary embodiment of the present invention;

FIG. 4 is a diagram of a special purpose keyboard having the present special purpose interface implemented thereon as a plurality of manually articulable keys or the like, for selecting special purpose objects that correspond with Biblical citations in accordance with an exemplary embodiment of the present invention;

FIG. 4 depicts the use of the presently described special purpose keyboard simultaneously with a conventional QWERT keyboard on a computer in accordance with an exemplary embodiment of the present invention; and

FIG. 6 is a flowchart depicting a process for implementing the special purpose interface (and keyboard) on a computer in accordance with an exemplary embodiment of the present invention;

Other features of the present invention will be apparent from the accompanying drawings and from the following detailed description.

### DETAILED DESCRIPTION OF THE INVENTION

Element Reference Number Designations

| | |
|---|---|
| 100: Special purpose interface | 161: Citation window |
| 102: ENTER object | 162: Version window |
| 104: Numeric objects | 163: Language window |
| 110O: Old Testament objects | 170: Screen pointer |
| 110N: New Testament objects | 160L: Left column display window |
| 112: Chapter object | 162L: Left column citation window |
| 112A: Chapter navigation object | 164L: Left column version window |
| 114: Verse object | 166L: Left column language window |
| 114A: Verse navigation object | 160R: Right column display window |
| 130: Display language objects | 162R: Right column citation window |
| 140: Version objects | 164R: Right column version window |
| 150: Multimedia control objects | 166R: Right column language window |
| 151: Audio selection object | 202: Screen text |
| 152: Screen side selection object | 202L: Left column screen text |
| 153: Save screen data object | 202R: Right column screen text |
| 154: Retrieve screen object | 400: Special purpose keyboard |
| 155: Delete screen object | 402: Leg |
| 160: Optional display window | 500: QWERT keyboard |

In the following description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following description is, therefore, not to be taken in a limiting sense. For clarity of exposition, like features shown in the accompanying drawings are indicated with like reference numerals and similar features as shown in alternate embodiments in the drawings are indicated with similar reference numerals.

The present invention is directed to a human interface for interacting with a Bible reading program. Prior art Bible interface are known but rely heavily on standardized interface objects for presenting Biblical data. While younger users are versed in the use of these objects and techniques for using them, more senior users find them difficult to use because they are often counter-intuitive to finding data in a written text. The present invention provide a useful interface that can be used on any computing device with a display screen, yet is intuitively similar to researching data on a written text. The present invention will be described in connection with a Bible, however the use of a Holy Bible is merely for describing and is not meant to limit the scope of the invention in any way. The present human interface may be embodied as a special purpose graphical user interface that is displayed on a computer display screen, a special purpose touch screen, a physical keyboard with special function tactile keys or alternatively as some combination of the above.

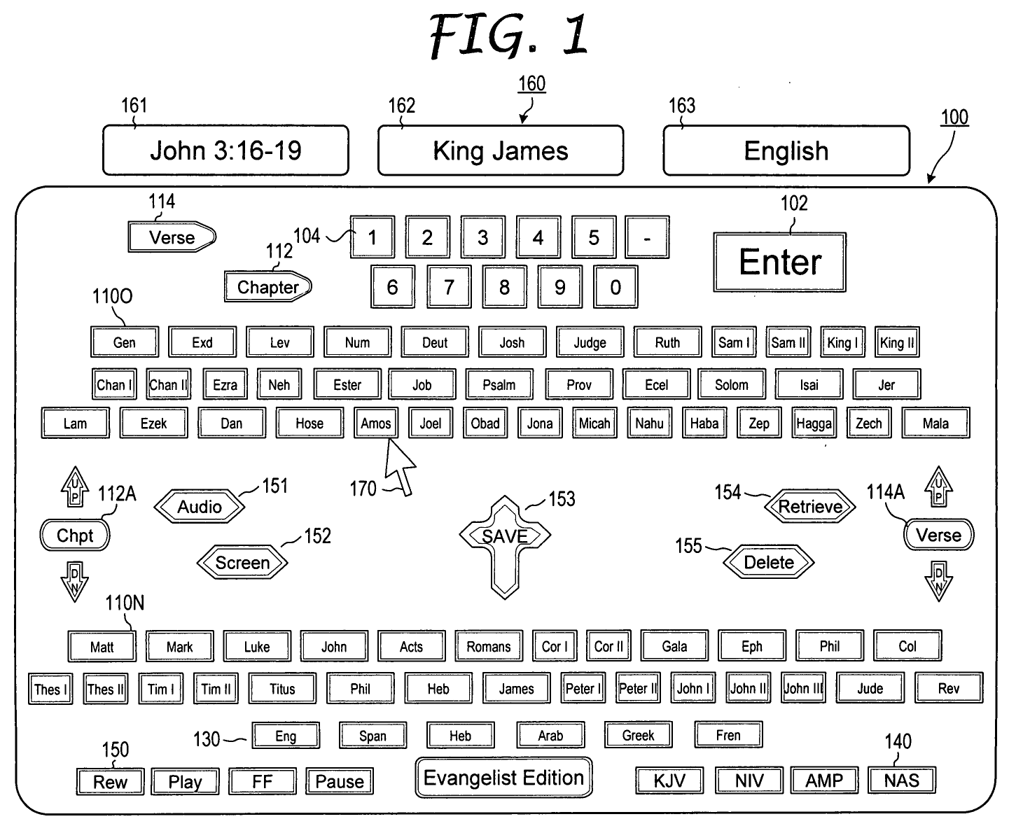

The present special purpose interface is adapted for accessing and perusing sacred text in electronic form on a display screen. FIG. 1 is a diagram of a special purpose interface for efficiently accessing Biblical sacred text in accordance with an exemplary embodiment of the present invention. The special purpose interface is logically subdivided into several zones with related objects. For the purposes of describing the present invention, an object may be a graphical object displayed on a computer screen, a graphical interactive object displayed computer screen for interaction with a screen pointer gesture, a graphical interactive object displayed touch screen for interaction with a touch gesture (stylus or human touch) and/or a tactile interactive object on a keyboard for manual interaction with human touch. The layout of exemplary special purpose interface 100 is exemplary and may be modified without departing from the scope of intent of the present invention.

As exemplary special purpose interface 100 is directed to interfacing with electronic text from a version of the Holy Bible, it comprises objects designated to the three indexing categories of a Bible: Books, chapters and verses of the sacred text corresponding to separate versions that may be displayed (or perceived) in a specific language. As many sacred text are often translated at different chronological times from a single original document, and because the phonetic, morphological, semantic, syntactic, and other features of a language change over time, and further because a translation of a sacred text may be supplemented with parallel idioms and the like, unique versions of the sacred text may simultaneously exist. Using the present special purpose interface, these are separately accessible for display using separate objects that identify specific variants of the sacred text. Therefore, in accordance with other exemplary embodiments of the present invention, the present special purpose interface comprises graphical objects corresponding to separate “Bible text” objects 140 that identify variants and versions of the sacred text. For example, the user may select, for example, the King James Version (KJV), the New International Version (NIV), the Amplified Bible (AMP) or New American Standard (NAS) for previewing a particular passage. An optional display window 160 is provided in the display space of the screen for visually acknowledging the user's input gestures for the variant or version at version entry 162. Additionally, and in accordance with other exemplary embodiments of the present invention, the present special purpose interface further comprises graphical objects corresponding to individual language objects 130 that identify a display or audio language for a selected text. An optional display window 160 in the display space of the screen may also comprise language entry 163 for visually acknowledging the user's input gestures for the language. For example, as depicted in FIG. 1, the King James Version in the English language as shown in entries 162 and 163 of window 160. Optionally, a default version and language may be selected in advance that designates a specific Bible version and display language, for instance the King James Version in the English language.

Subsequent to selecting a version and language, the user enters the Biblical citation in an identical manner and syntax as is customary for a Biblical citation using exemplary special purpose interface 100. Hence, the user need not be skilled, or even understand the use of standardized graphical user interfaces, linked indexes, hypertext documents or Web pages for accessing and displaying a particular passage. The user need only enter the passage on special purpose interface 100 exactly in the standardized citation syntax.

In its most uncomplicated form, exemplary special purpose interface 100 enable the user to access specific Bible Books, and/or Bible chapters and/or Bible verses in the identical manner as using a printed text, by selecting the indexing elements in the identical order as the accepted Biblical citation nomenclature or syntax, for example <book><chapter(s)><verse(s)>.

With the version and display language selected, a specific Book may be selected in its entirety, by interacting with the corresponding book objection, a chapter in a Book by interaction with the book object and designating a chapter within the Book by using a combination of the “Chapter” object and numeral objects, and a verse within a chapter by interaction with the book object, designating a chapter within the Book with a combination of the “chapter” object and numeral objects, and then designating one or more verses within the chapter with a combination of the “verse” object and numeral objects. In accordance with one exemplary embodiment of the present invention, every Book is represented on exemplary special purpose interface 100 by an object that identifies the Book. In exemplary special purpose interface 100 illustrated in FIG. 1, the Books are separated into Old Testament objects 110O and New Testament objects 110N, in a manner suggestive of a written Bible and as is often referenced in a citation. Each Book is represented by a particular graphical object on exemplary special purpose interface 100; the area of each may be equivalent or alternatively corresponding to the importance popularity or designation of the Book. For example, the area for object corresponding to the Wisdom Books of the Old Testament, i.e., Job, Psalms, Proverbs, Ecclesiastes and (Song of) Solomon, may be slightly larger than the object corresponding to the Minor Prophets, i.e., Hosea, Joel, Amos, Obadiah, Jonah, Micah, Nahum, Habakkuk, Zephaniah, Haggai, Zechariah and Malachi.

The user selects, by articulating the respective objects, the indexing elements in the identical order as the accepted Biblical citation nomenclature or syntax, for example <book><chapter(s)><verse(s)>. For example, if the user desires to view the Book of John, the user merely selects the “John” object from New Testament Book objects 110N and interacts with it. If special purpose interface 100 is a graphical user interface displayed computer screen, the user manipulates optional screen pointer 170 to the location of the “John” object, using, for example a mouse and interacts with it, usually by depressing the left mouse key and then the ENTER object. If special purpose interface 100 is a graphical user interface on a touch screen, the user merely touches the screen with a finger or stylus at the location of the “John” object on the screen, followed by the ENTER object. In the description above, special purpose interface 100 may be considered a virtual counterpart to a special purpose keyboard. If, on the other hand, purpose interface 100 is a tactile interactive device, i.e., a keyboard, the user merely locates and depresses the key labeled “John” in the usual manner as in the standard QWERT keyboard, followed by the key labeled ENTER. Optionally, the display screen may contain window 160 for acknowledging user selections. In response to any of the selections described above, optionally, “John” is displayed in window 161 on the display screen. Other Books are selected similarly, if the user desires to view the Book of Genesis, the user merely selects the “Genesis” object from Old Testament Book objects 110O and interacts with that object followed by the ENTER.

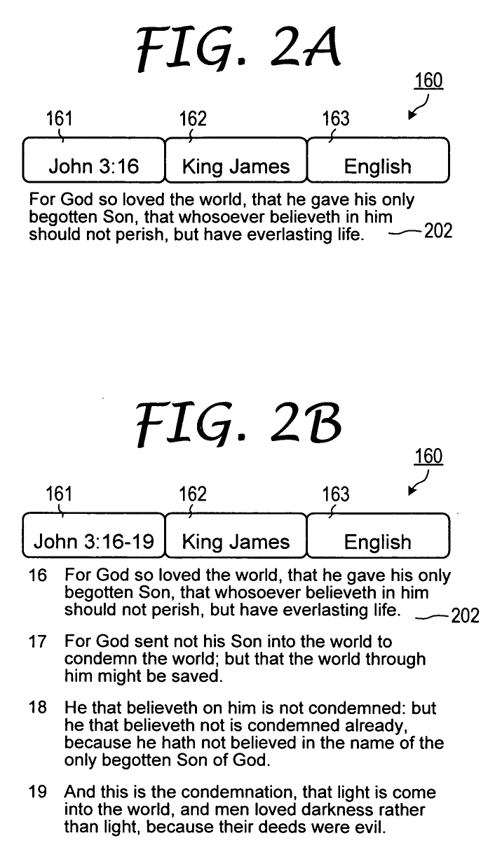

Selecting chapters and verses are similar and just as intuitive as selecting the Books. For example, if the user desires to view the chapter 3 of the Book of John, the user merely selects the “John” object from New Testament Book objects 110N, as before, followed by the “chapter” object and the “3” object followed by the ENTER object. If the user desires to view a specific verse in the third chapter of the Book of John, for instance the sixteenth verse, the user merely selects the “John” object, followed by the “chapter” object, the “3” object and then the “verse object followed by the “1” and “3” objects and the ENTER object. The screen display for the above example is depicted in FIG. 2A with “John 3:16” shown in entry 161, “King James” in entry 162 and “English in entry 163 of display window 160. Notice that the English language passage for John 3:16 is depicted as text 202 from the King James Version of the Holy Bible. Below in table I is a partial listing of exemplary Bible citations with their associated interaction objects.

TABLE I

| | Book | Chapter | Verse | Objects |
|---|---|---|---|---|
| John | John | 3 | | <John><Enter> |
| John 3 | John | 3 | | <John><Chapter><3><Enter> |
| John 3:16 | John | 3 | 19 | <John><Chapter><3><Verse><1><6><Enter> |
| Genesis 1-2 | Genesis | 1 and 2 | | <Genesis>><Chapter><1><—><2><Enter> |
| John 3:16-19 | John | 3 | 16 through 19 | <John><Chapter><3><Verse><16><—><19><Enter> |

The user may navigate to another passage from John 3:16 by entering another Bible citation as discussed above, or by interacting with navigation objects 114A and 112A. For example, by interacting with the “UP” arrow at verse navigation object 114A, text 202 changes from passage John 3:16 to display the text of John 3:15 “That whosoever believeth in him should not perish, but have eternal life” and entry 161 changes to display “John 3:15” (neither shown). Chapters within a Book can be navigated similarly using chapter navigation object 112A, and/or chapters and verses together using navigation objects 112A and 114A together. Entry 161 will reflect navigation changes that occur from interacting with the ENTER object.

The screen display for the fifth line of Table I is depicted in FIG. 2B with “John 3:16-19” shown in entry 161, “King James” in entry 162 and “English” in entry 163 of display window 160. Notice here that each of verses 16 through 19 are presented and, optionally, indexed by verse number within text 202.

In accordance with still other exemplary embodiments of the present invention, special purpose interface 100 may further comprise objects for accessing and navigation though media other than text. For instance, special purpose interface 100 comprises “Audio” object 151 for designating an audio version of a selected passage for playback. An initial selection of a passage may be made similarly to the selection of visual text described above using the book, chapter and verse objects, or may instead be made by highlighting a portion of text 202 on the display screen. In either case, multimedia navigation objects 150 are provided for navigating through an audio media.

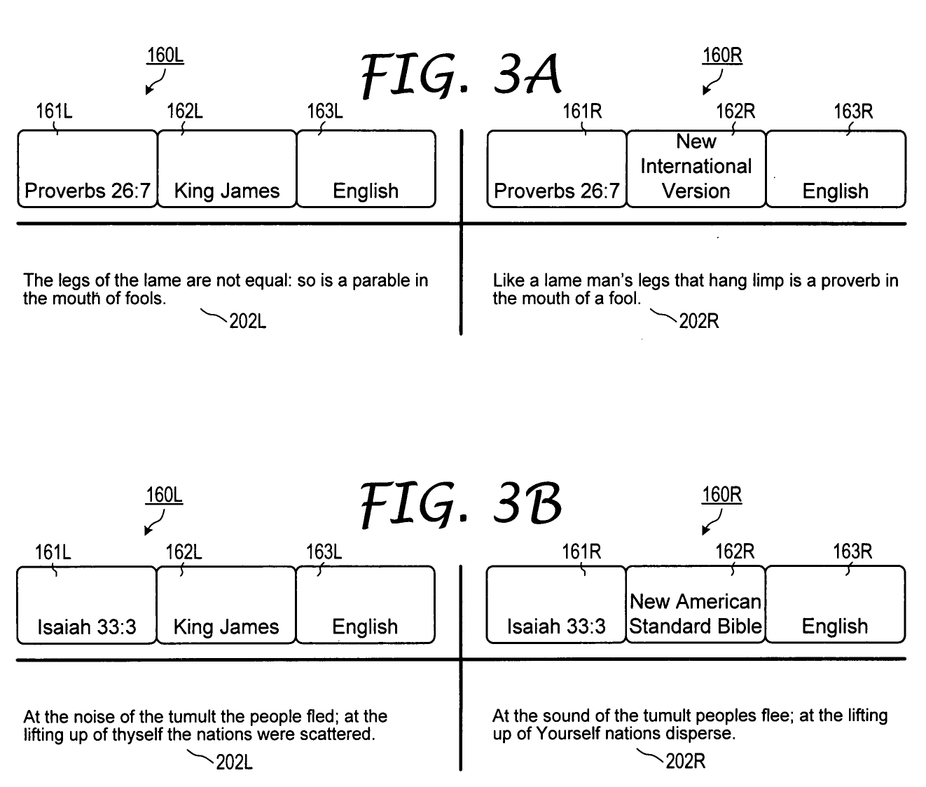

In accordance with still another exemplary embodiment of the present invention, special purpose interface 100 can be used for making visual comparisons between different versions of the sacred text, or even between Books, chapters or verses, and different presentation languages. “Screen” object 152 toggles the current presentation between, for example, the left and right column positions on the display screen. FIGS. 3A and 3B are illustrations of an exemplary display screen in which passages of Bible scripture have been presented for a direct visual comparison in accordance with an exemplary embodiment of the present invention. FIG. 3A depicts a comparison between the King James version of Proverbs 26:7 in left display window 160L with the New International Version in right display window 160R. In practice, the user selects “King James Version” Bible text object 140, “English” language object 130 and then the “Proverbs” Old Testament Book object 110O, “Chapter” object 112, followed by “2” and “6” numeric objects 104 and finally “Verse” object 114, followed by a “7” numeric object 104. The entry is then acknowledged by the user with the ENTER object. Toggling “Screen” object 152 will reposition the passage to the opposite display window for presentation on the display screen, the default window is left display window 160L if empty, otherwise the passage is present in right display window 160R. For display a passage in right display window 160R, the user toggles “Screen” object 152 to display in right display window 160R and then selects “New International Version” Bible text object 140. Then, she selects the remainder of the citation as described above, “English” language object 130, “Proverbs” Old Testament Book object 110O, “Chapter” object 112, “2” and “6” numeric objects 104 followed by “Verse” object 114 and a “7” numeric object 104 and ENTER. Alternatively, the software program presents a comparison object in the opposing display windows based on only differences in the citation. Hence, if the user merely selects a different version, or language, then the program presents the same passage, but as a different version or display language. FIG. 3B depicts a comparison between the King James and New American Standard Bible versions of Isaiah 33:3 in left display window 160L and right display window 160R, respectively.

In accordance with still other exemplary embodiments of the present invention, special purpose interface 100 further comprises file objects for organizing selected passages and comparisons in computer memory. For example, a user may select various comparisons of a particular passage in left display window 160L and right display window 160R and then save various comparisons and/or displayed passages using “Save” object 153. Any stored passages/comparisons may be retrieved from memory using “Retrieve” object 154 thereby negating the necessity for manually designating the citation(s). Passages/comparisons that are no longer needed can be purged from memory using “Delete” object 155. Additionally, “Delete” object 155 may also be used for clearing a display window.

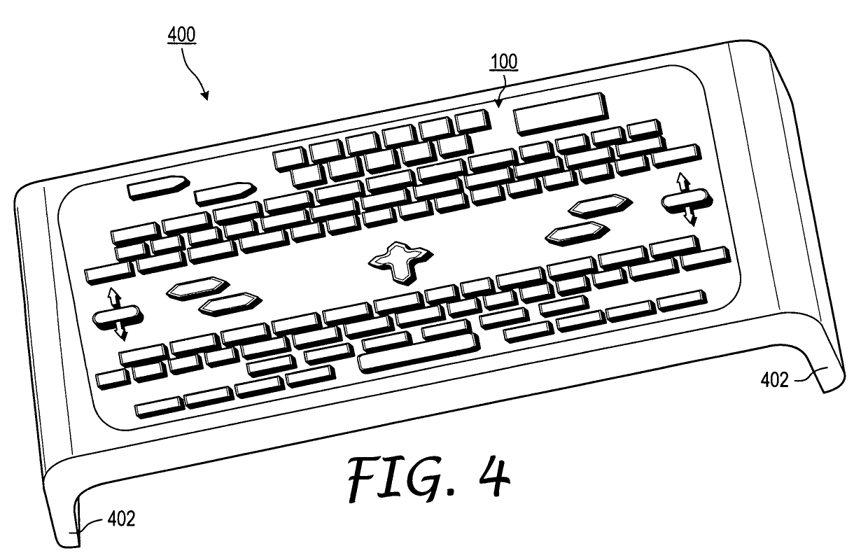

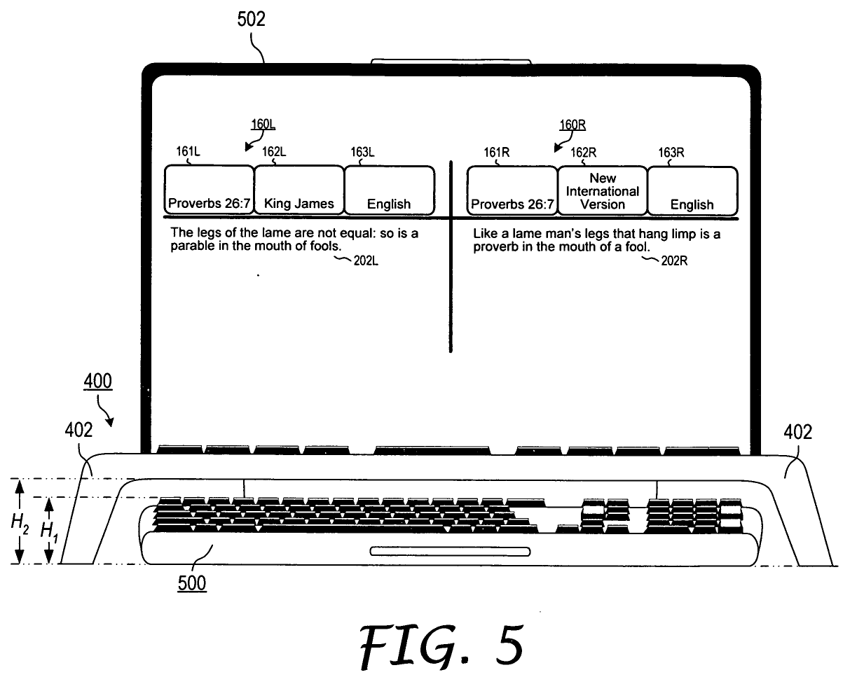

In accordance with one exemplary embodiment of the present invention, the present special purpose interface may be implemented as or on a keyboard device for simultaneous use with the standard QWERT keyboard coupled to a PC. FIG. 4 depicts a special purpose keyboard having the present special purpose interface implemented thereon as a plurality of manually articulable keys or the like, for selecting special purpose objects that correspond with Biblical citations in accordance with an exemplary embodiment of the present invention. Special purpose keyboard 400 comprises a manually articulable interface 100 interface, with the bottom surface of special purpose keyboard 400 elevated to a height of H₂ (see FIG. 5 which depicts special purpose keyboard 400 over conventional QWERT keyboard 500). One purpose of the present invention is to use the invention simultaneously with a standard QWERT keyboard having an upper height of H₁, this may be a conventional wired, wireless or laptop keyboard. Leg 402 creates a cavity beneath special purpose keyboard 400, thereby allowing the placement on top of the QWERT keyboard without actuating its keys. Most QWERT keyboards, for either a PC or laptop, are less than 2.50 inches in height, hence the bottom surface of special purpose keyboard 400 should be greater than that, H₂≧2.5 inches, although legs 402 may be provided with height adjustment for accommodating higher keyboards and lowering the elevation for shorter keyboards. The span between the left and right legs 402 should accommodate a conventional keyboard having a width of eighteen inches. It should be mentioned that special purpose keyboard 400 may be configured with two, three or four legs 402 that are strategically positioned near the front in order to create an unobstructed cavity in the rear for receiving a relatively large conventional keyboard.

FIG. 5 is a diagram depicting a spatial relationship between special purpose keyboard 400 to conventional QWERT keyboard 500 in accordance with an exemplary embodiment of the present invention. Special purpose keyboard 400, as described above, generally comprises special purpose interface 100 as a plurality of manually articulable interaction objects, usually keys. Special purpose keyboard 400 is elevated above conventional QWERT keyboard 500 by one or more legs 402. Legs 402 may be stationary or adjustable in order to accommodate higher QWERT keyboards. Behind special purpose keyboard 400 and QWERT keyboard 500 is display screen 502 (shown with the presentation of FIG. 3A). Optimally, QWERT keyboard 500 nestles in a cavity underneath special purpose keyboard 400 created by elevating special purpose keyboard 400 above QWERT keyboard 500 with legs 402. Ideally, special purpose keyboard 400 will occupy little more footprint on the user's workspace that QWERT keyboard 500.

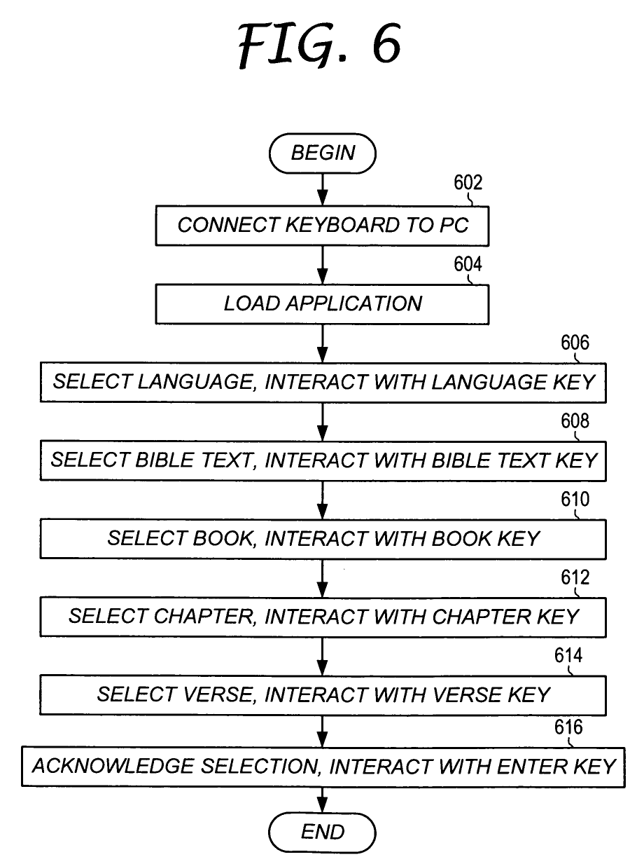

FIG. 6 is a process for utilizing special purpose keyboard 400 in accordance with an exemplary embodiment of the present invention. The process begins by connecting special purpose keyboard 400 to the computer (step 602). Special purpose keyboard 400 is generally positioned directly over QWERT keyboard 500 as described above, and connects to the computer via some means that does not require disconnecting QWERT keyboard 500. QWERT keyboard 500 may be a keyboard to a conventional PC or a laptop keyboard. For example, by connecting special purpose interface keyboard 400 to the computer in combination with the standard QWERT keyboard, such as the Universal Serial Bus (USB), or wireless technology such as a proprietary wireless scheme, Bluetooth or even WiFi wireless networking technology. In addition, the present special purpose interface keyboard comprises legs or other means for elevating the special purpose keyboard, in place and above the QWERT keyboard connected to the PC. This enables both keyboards to operate in the same physical footprint at a computer station. Next, the software application for viewing the passages is loaded to the computer, if not already running (step 604). Next, a display language is selected (step 606) followed by the Bible text (step 608) using special purpose interface keyboard 400. A passage can then be displayed on screen 502 by selecting the Book (step 610), the chapter (step 612) and the verse (step 614) in the precise manner of a conventional citation (specific object interactions discussed elsewhere above). Finally, the user acknowledges the selection with the ENTER key (step 616). Additionally, the passage may be toggled on the left or right column of the display screen using the “Screen” key, or produced as an audible presentation using the “Audio” key. Other passages are displayed similarly. Presentations that are useful may be saved in memory for later usage using the “Save” key and retrieved from memory using the “Retrieve” key.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Moreover, the computer readable medium may include a carrier wave or a carrier signal as may be transmitted by a computer server including internets, extranets, intranets, world wide web, ftp location or other service that may broadcast, unicast or otherwise communicate an embodiment of the present invention. The various embodiments of the present invention may be stored together or distributed, either spatially or temporally across one or more devices.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The exemplary embodiments described below were selected and described in order to best explain the principles of the invention and the practical application, and to enable others of ordinary skill in the art to understand the invention for various embodiments with various modifications as are suited to the particular use contemplated. The particular embodiments described below are in no way intended to limit the scope of the present invention as it may be practiced in a variety of variations and environments without departing from the scope and intent of the invention. Thus, the present invention is not intended to be limited to the embodiment shown, but is to be accorded the widest scope consistent with the principles and features described herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A special purpose interface device for accessing computerized content of a sacred text comprising:
plurality of articulable version objects, each articulable version object for accessing a unique version of the sacred text comprising:
a version nomenclature for identifying a unique version type of the sacred text;
a plurality of articulable language objects, each articulable language object for accessing a unique language translation of a version type of the sacred text comprising:
a language nomenclature for identifying a unique language of a version of the sacred text;
a plurality of articulable book objects, each articulable book object for accessing content of a book of the sacred text comprising:
a book nomenclature for identifying a unique book of the sacred text;
an articulable chapter object for accessing content of a chapter within a book of the sacred text;
an articulable verse object for accessing content of a verse within a chapter of the sacred text;
a plurality of articulable numeric objects, each articulable numeric object for designating a numeric identifier associated with one of a chapter and a verse comprising:
a numeral nomenclature identifying a unique numeral; and
an articulable display object for designating a visual display of at least a portion of a book of the sacred text.

2. The special purpose interface device in claim 1, further comprises:
a plurality of articulable multimedia objects for accessing multimedia content of a book of the sacred text.

3. The special purpose interface device in claim 3, wherein the plurality of articulable multimedia objects further comprises objects for manipulating multimedia content of the book of the sacred text.

4. The special purpose interface device in claim 1, further comprises:
a plurality of articulable file objects for accessing previously display content of a book of the sacred text stored in memory.

5. The special purpose interface device in claim 4, wherein the plurality of articulable file objects further comprises objects for manipulating previously display content of the book of the sacred text.

6. The special purpose interface device in claim 1, wherein the special purpose interface device further comprises a plurality of graphical user interface objects displayed on a display screen that utilizes a screen pointer for designating a graphical user interface object for interaction.

7. The special purpose interface device in claim 1, wherein the special purpose interface device further comprises a plurality graphical user interface objects displayed on a touch screen that utilizes one of a user digit and stylus designating a graphical user interface object for interaction.

8. The special purpose interface device in claim 1, wherein the special purpose interface device further comprises a plurality of manually articuable keys on a special purpose keyboard that for manual interaction.

9. The special purpose interface device in claim 8, wherein the special purpose keyboard further comprises:
a body having an upper surface wherein the plurality of manually articuable keys are disposed and a lower surface; and
at least one leg connected to the body for creating a cavity beneath the lower surface of the special purpose keyboard, thereby allowing for placement on top of a conventional keyboard without actuating keys of the conventional keyboard.

10. The special purpose interface device in claim 9, wherein the at least one leg has a height of at least one and a half inch, resulting in said cavity having a height of at least one and a half inch.

11. The special purpose interface device in claim 8, wherein the special purpose keyboard is electrically connected to a computer through wired connection to a serial bus.

12. The special purpose interface device in claim 8, wherein the special purpose keyboard is electrically connected to a computer through wireless connection.

13. The special purpose interface device in claim 8, wherein the special purpose keyboard is electrically connected to a computer simultaneously with a conventional keyboard.

14. The special purpose interface device in claim 1, wherein a passage of the sacred text is identified using syntax of interacting with an articulable book object, followed by interacting with an articulable chapter object and then followed by interacting with an articulable verse object.
